(19) United States
(12) Patent Application Publication
(10) Pub. No.: US 2026/0128880 A1
(43) Pub. Date: May 7, 2026

(54) METHOD AND SYSTEM FOR IMPLEMENTING A PRIVACY PRESERVING, FACE-BASED PROTECTED PUBLIC KEY INFRASTRUCTURE

(71) Applicant: Seventh Sense Artificial Intelligence Private Limited, Singapore (SG)

(72) Inventors: Varun Chatterji, Singapore (SG); Ashish Kushwaha, Singapore (SG)

(73) Assignee: Seventh Sense Artificial Intelligence Private Limited, Singapore (SG)

(21) Appl. No.: 19/484,922

(22) PCT Filed: May 17, 2024
(86) PCT No.: PCT/EP2024/063711

§ 371 Date: Nov. 17, 2025

(30) Foreign Application Priority Data
May 19, 2023 (SG) 10202301398S

(51) Int. Cl. H04L 9/30; H04L 9/08; H04L 9/32

(52) U.S. Cl. CPC H04L 9/30; H04L 9/0825; H04L 9/0866; H04L 9/3213; H04L 9/3231; H04L 9/3236; H04L 9/3247; H04L 9/3263

(57) ABSTRACT

A computer-implemented method of registering a user identifier in a public key infrastructure comprising a trusted device and a server is provided. The method includes the steps: receiving the user identifier as an input to the trusted device; obtaining a hash value of the user identifier; the trusted device obtaining biometric data comprising a facial image of the user; generating a public key and a privacy preserving data structure using the biometric data, encrypting the user identifier using the public key, and storing the encrypted user identifier as metadata in the privacy preserving data structure, wherein a private key for decrypting the encrypted user identifier can be generated from the privacy preserving data structure using subsequently acquired biometric data comprising the facial image of the user; generating a device token corresponding to the trusted device and obtaining a hash value of the device token, the server storing the privacy preserving data structure uniquely indexed by the hash value of the device token while using the hash value of the user identifier as a primary key, and the trusted device storing the device token.

This application claims priority from SG 10202301398S filed 19 May 2023, the contents and elements of which are herein incorporated by reference for all purposes.

### FIELD OF THE INVENTION

The present invention relates to computer-implemented methods, devices, and systems for face-based authentication of a user in a public key infrastructure.

### BACKGROUND

Public Key Infrastructure is common in scenarios where information must be signed or encrypted with non-repudiation and authenticity in mind. In such scenarios, there is typically a trusted root Certificate Authority (CA) that can generate a certificate vouching for the identity (and public key) of an end-user.

Documents can then be signed with end-user's private key, and the signature can be verified by validating it against the signed public key contained in the certificate issued by the root CA.

Since the root CA is trusted, and its public key is known (via a self-signed certificate), certificates issued by the CA can be verified using the CA's root certificate, and since they contain identity information of the end-user, the end-user's identity information can be safely associated with their public key by virtue of the certificate issued to them by the root CA.

Present document signing systems typically employ e-signatures where documents are annotated with visible signatures in signing fields. Such methods typically send the document via email and maintain an audit trail of when events occurred. Documents can typically be opened from emails and users can either draw, or adopt a signature based on available fonts. Once the document is e-signed by all parties, the signing platform may add the audit trail page and cryptographically sign the document as completed by using its own private key.

However, such documents can be contested in court under the clause of plausible deniability. Plausible deniability is the ability of people, typically senior officials in a formal or informal chain of command, to deny knowledge of or responsibility for actions by members of their organizational hierarchy. Since, in many situations, executives have secretaries with access to their email, the e-signing regime can be easily contested in court by an executive claiming that the secretary signed the document and not them.

Facial recognition-based user authentication methods identify users by their unique biological features. Secure websites can use such methods for signing in its users, providing an effective means of user authentication without requiring the users to recall a password. Typically, users sign up on the website by supplying a biometric sample of their facial features to generate a feature template which is stored in a database as biometric data. Later, when the user presents another biometric sample, a new feature template is generated and compared with the previously stored template. If the respective feature templates are found to be sufficiently similar, the system deems that the same person supplied each sample. In this regard, the feature templates are ‘linkable’. The ability to compare feature templates with one another is also what makes the stored data biometric in nature. However, in the context of data protection, this is an undesirable property of biometric data because it is possible to identify the user from their biometric data.

Another concern with traditional facial recognition-based user authentication methods is that one feature template can be generated from a single biometric sample. Therefore, if the feature template is compromised, the user cannot generate a new feature template as a replacement. This is analogous to having a password that cannot be changed.

The present invention has been devised in light of the above considerations.

### SUMMARY OF THE INVENTION

Broadly, the present invention relates to systems and methods for face-based authentication of a user in a public key infrastructure. In particular, biometric data comprising a facial image of a user is used to generate a public key and a privacy preserving data structure which can be used to generate a corresponding private key. The corresponding private key can only be generated from the privacy preserving data structure using subsequently acquired biometric data comprising the facial image of the user that was used to generate the privacy preserving data structure. Therefore, the privacy preserving data structure enables the user to protect the private key using their biometric data by ensuring that the corresponding private key can only be generated at run time from the user's face. The privacy preserving data structure may store entropy which is used in conjunction with the subsequently acquired biometric data to generate the private key. The privacy preserving data structure may contain encrypted metadata relating to the user which can only be decrypted using the corresponding private key. Although an ‘incorrect’ private key may be generated using a different facial image, the incorrect private key would not be able to decrypt the encrypted metadata stored in the privacy preserving data structure. Thus, the act of decrypting the encrypted metadata successfully is an act of biometric authentication of the user using the subsequently acquired facial image.

There are multiple known ways to generate such a privacy preserving data structure having these properties. For example, some common approaches are set out in international standard ISO/IEC 30136:2018 the contents of which is incorporated herein by reference. Commercial offerings are available for practitioners in the field to utilise such privacy preserving data structures for achieving the purpose of this invention.

Presented below are different aspects of the present invention, each aspect having different optional features. These aspects and optional features are combinable in any combination unless the context demands otherwise.

In a first aspect there is provided a computer-implemented method of registering a user identifier in a public key infrastructure, the public key infrastructure comprising a server and a trusted device, the method including:
receiving the user identifier as an input to the trusted device;
obtaining a hash value of the user identifier;
the trusted device obtaining biometric data comprising a facial image of the user;
generating a public key and a privacy preserving data structure using the biometric data, encrypting the user identifier using the public key and storing the encrypted user identifier as metadata in the privacy preserving data structure, wherein a private key for decrypting the encrypted user identifier can be generated from the privacy preserving data structure using subsequently acquired biometric data comprising the facial image of the user;
generating a device token corresponding to the trusted device and obtaining a hash value of the device token;
the server storing the privacy preserving data structure uniquely indexed by the hash value of the device token while using the hash value of the user identifier as a primary key; and
the trusted device storing the device token.

By using the privacy preserving data structure to protect the private key with the biometric data of the user, only the user is able to generate their private key-i.e. the private key corresponding to the public key. Due to the non-biometric nature of the privacy preserving data structure, the server is never required to store facial images of the user. Therefore, the method preserves the user's privacy and improves data security.

Biometric data comprising the facial image of the user may refer to an image of the user's face or data which is derived from an image of the user's face. While the use of biometric data comprising the facial image of the user is preferred, other types of biometric data are contemplated. For example, the biometric data may comprise, in any combination, one or more of: a fingerprint scan, a palm-print scan, an iris scan, a retina scan, and a voice recording.

Preferably, the public key and the privacy preserving data structure may be generated by the server. For example, the method may include the trusted device forwarding the biometric data to the server. The method may include the trusted device forwarding the user identifier to the server and the server encrypting the user identifier with the public key.

The method may include the server requesting a public key certificate from a certificate authority for the public key and the user identifier and the certificate authority storing the public key certificate in a public key registry. When the user presents the user identifier, the user can be authenticated based on the public key certificate and the private key. Preferably, the public key certificate is accessible from the public key registry by reference to the user identifier. Therefore, the public key infrastructure may further comprise the certificate authority and the public key registry.

By generating a device token for the trusted device and storing the privacy preserving data structure uniquely indexed by the hash value of the device token and using the hash value of the user identifier as the primary key, the user is prevented from registering the user identifier more than once, for example, using different devices. Additionally, any facial image received by the server must be authenticated by also sending the device token of the trusted device to the server. The trusted device provides an additional layer of security for granting access to the privacy preserving data structure stored in the server. Preferably, the device token is generated by the server and transmitted to the trusted device. However, it is contemplated that the trusted device may generate the device token. Preferably, the device token is a universally unique identifier (UUID).

In preferred embodiments, the server may obtain the hash value of the user identifier and store the privacy preserving data structure indexed by the hash value of the user identifier and the hash value of the device token, respectively. The hash value of the user identifier and/or the hash value of the device token may be obtained using a SHA256 hashing algorithm. This allows the trusted device to be used for authenticating more than one user identifier. However, a user identifier may not be authenticated using more than one trusted device. While the hashing of the device token and/or the user identifier occur in the server in preferred embodiments, the hashing of these elements is also contemplated to occur on the trusted device, with the server operating on only the respective hash values.

Preferably, (un-hashed) copies of the user identifier and the device token on the server are discarded after transmitting the device token to the trusted device. Therefore, the server preferably does not store any unencrypted or un-hashed user identifiable information. Since the privacy preserving data structure is indexed by the hash value of the device token, and optionally the hash value of the user identifier, there is no way to retrieve the privacy preserving data structure associated with a corresponding user on the server without first receiving the device token or the user identifier from the trusted device. Hence, the server alone has no way of knowing which privacy preserving data structure corresponds to which user. This improves data security as a third party cannot trace the privacy preserving data structure to the user. Additionally, all subsequent cryptographic operations must be authenticated with the device token issued to the trusted device, which can be maintained solely in the user's possession.

The trusted device may be a mobile device, e.g. a smartphone or tablet. The trusted device may communicate with the server via an app installed on the trusted device. Upon each start of the app, the app may use security methods such as device integrity checks to ensure that the trusted device is uncompromised. If a spurious device is detected, the app may cease to function and/or delete data associated with the app. This can reduce the risk of injection attacks in which a video or high-resolution image is presented to the trusted device instead of a live biometric presentation.

The user identifier may comprise a means of contacting the user. For example, the user identifier may be an email address, a phone number, a crypto wallet identifier, or a physical address.

The method may include verifying that the user identifier belongs to the user, e.g. before generating the public key, e.g. before obtaining the biometric data. A password (e.g. a one-time password (OTP)) may be sent to the user by the server and the user may input the password on the trusted device. For example, the password may be sent to the email address, the phone number, the crypto wallet identifier, or the physical address.

The method may include checking if the user identifier is associated with an existing account, e.g. an existing privacy preserving data structure stored on the server. For example, the server may obtain a hash value of the user identifier forwarded by the trusted device and search for an equivalent hash value stored on the server, e.g. as an index to the existing privacy preserving data structure. The method may include determining that the user identifier has not been registered if the hash value of the user identifier is not stored on the server and determining that the user identifier has been registered if the hash value of the user identifier is stored on the server.

The server may indicate to the trusted device whether or not the user identifier has been registered.

The method may include authenticating the user if the user identifier has been registered. If the user is authenticated, the server may proceed to generate the device token corresponding to the trusted device. The device token may be a new device token to replace an existing device token associated with the user identifier. This ensures that only one public key certificate is issued per user identifier and that only one trusted device can be used to gain access to the private key. The method may include automatically logging out a previous trusted device associated with the existing device token. In other words, the app may cease to function on the previous trusted device.

Authenticating the user may include obtaining subsequently acquired biometric data comprising the facial image of the user and determining whether or not the subsequently acquired biometric data corresponds to the user identifier stored on the server. This may include the server retrieving the privacy preserving data structure by reference to the hash value of the user identifier, generating a private key from the privacy preserving data structure using the subsequently acquired biometric data, and decrypting the encrypted user identifier stored in the privacy preserving data structure using the private key to authenticate the user. The method may include determining that the user identifier has been decrypted by matching the user identifier stored as the metadata to the user identifier forwarded to the server.

The method may include the trusted device returning an error if the user cannot be authenticated, e.g. if encrypted user identifier stored in the privacy preserving data structure cannot be decrypted by the private key or if the decrypted identifier doesn't match the user identifier supplied by the trusted device. For example, the server may indicate to the trusted device that the user could not be authenticated.

If the user identifier has not been registered, then the trusted device may proceed to verifying that the user identifier belongs to the user or obtaining the biometric data comprising the facial image of the

The public key certificate may be requested by the server by sending a certificate signing request (CSR) to the certificate authority. Preferably, the certificate authority is a cloud private certificate authority service. Additionally, it is also contemplated that the process of obtaining the certificate may be performed via an application programming interface (API) call to a public certification authority such as, but not limited to, GlobalSign. When the certificate is issued by a public certification authority in the Adobe Approved Trust List (AATL), the signing of PDF documents and the subsequent verification of signatures through Adobe's software is facilitated.

The method may include registering an additional user identifier using the trusted device. For example, the server may determine that the additional user identifier has not been registered. The method may include verifying that the additional user identifier belongs to the user.

The method may include generating an additional public key using the biometric data and the additional user identifier. The additional user identifier may be encrypted using the additional public key and stored as metadata in the privacy preserving data structure. The method may further include generating an additional private key from the privacy preserving data structure using the biometric data and the additional user identifier. Each private key and public key may be generated using the respective user identifier as a unique string. By generating multiple key-pairs from the same privacy preserving data structure, each key-pair can be used to register a different user identifier. Therefore, multiple user identifiers can be associated with the same account and authenticated using the same trusted device.

Preferably, the privacy preserving data structure is stored on the server in a user table with the hash value of the user identifier forming a primary key of the user table. When an additional (e.g. secondary) user identifier is registered, the server or the trusted device may obtain a hash value of the additional user identifier and the server may store the hash value of the additional user identifier with the hash value of the (e.g. primary) user identifier in a mapping table. The hash value of the additional user identifier may form a primary key of the mapping table. Therefore, the mapping table maps the additional user identifier to the primary user identifier, which is stored in the user table. This allows multiple user identifiers (e.g. email addresses) to be stored efficiently on the server and linked to the same privacy preserving data structure. The user table may include the device token as a unique constraint for preventing the privacy preserving data structure being linked to more than one device token in the user table.

The/each public key certificate may be stored on the server, e.g. in an encrypted form. For example, the/each user identifier may be concatenated with a random nonce to form a symmetric key. The/each public key certificate may be encrypted using the respective symmetric key.

The hash value of the/each user identifier may provide the primary form of retrieval of the encrypted public key certificate. Given a user identifier, the corresponding public key certificate may be retrieved by obtaining the hash value of the user identifier. The public key certificate may then be decrypted using the symmetric key. Advantageously, this public key certificate storage scheme does not reveal personally identifiable information of its users.

While preferred embodiments relate to a centralised public key infrastructure, alternative methods using distributed storage and retrieval of data in public and/or private blockchains (e.g. Ethereum Balloon) are contemplated.

In a second aspect there is provided a computer-implemented method of signing a user into a website on a computing device using third-party authentication, wherein a user identifier of the user has been registered according to the method of the first aspect, the method comprising an authentication phase and a signing in phase,
wherein the authentication phase includes:
   redirecting the user from the website to a third-party sign-in page connected to the server;
   the third-party sign-in page displaying a unique code on the computing device;
   the trusted device receiving the unique code as an input;
   the trusted device obtaining subsequently acquired biometric data comprising the facial image of the user;
   transmitting the subsequently acquired biometric data, the unique code, the user identifier, and the device token to the server;
   the server obtaining a hash value of the device token and a hash value of the user identifier and retrieving the privacy preserving data structure by reference to the hash value of the device token and the hash value of the user identifier;
   generating a private key from the privacy preserving data structure using the subsequently acquired biometric data; and
   decrypting the encrypted user identifier stored as metadata using the private key to authenticate the user,
wherein the signing in phase includes:
   the server identifying the third-party sign-in page from the unique code; and
   communicating the authentication of the user to the third-party sign-in page for signing the user into the website on the computing device.

By providing third-party authentication, the website can improve its security by requiring its users to sign in using their biometric data. Further, only the user in possession of the trusted device is able to access the privacy preserving data structure stored on the server, thereby providing an additional layer of security for signing into the website.

The user may be redirected from the website to the third-party sign-in page in response to determining an intent of the user to sign in to the website. In this case, the third-party acts as an Identity Provider (IDP). Determining the intent of the user to sign in may be based on receiving the user identifier as an input on the website.

The unique code may be a QR code displayed on the computing device. Therefore, the trusted device may receive the unique code by scanning the QR code. A time and/or date of expiry may be embedded in the unique code. Therefore, the method may include the server determining whether or not the unique code has expired. If the server determines that the unique code has expired, then the trusted device may return an error instead of obtaining the subsequently acquired biometric data. However, connectionless polling-based protocols which periodically query a backend server from the frontend sign-in page are also contemplated.

By maintaining a connection with the third-party sign-in page, the server can instruct the third-party sign-in page to navigate elsewhere if the sign-in attempt succeeds. The unique code enables the server to identify the third-party sign-in page. The connection may comprise a socket. io connection.

The server may obtain a hash value of the user identifier transmitted from the trusted device and retrieve the privacy preserving data structure by reference to the hash value of the user identifier.

The trusted device may return an error if the server cannot retrieve the privacy preserving data structure by reference to the hash value of the device token, and optionally the hash value of the user identifier. This error may indicate that the trusted device is not associated with the user identifier on the server.

Additionally, or alternatively, the trusted device may return an error if the server can retrieve the privacy preserving data structure by reference to the hash value of the device token and/or the hash value of the user identifier but cannot authenticate the user.

Authenticating the user may include determining whether or not the subsequently acquired biometric data corresponds to the user identifier stored on the server (i.e. whether or not the subsequently acquired biometric data can be used to generate the correct private key to decrypt the metadata in the privacy preserving data structure). Therefore, the method may include determining that the user identifier has been decrypted by matching the user identifier stored as the metadata to the user identifier transmitted to the server.

The signing in phase may include the third-party sign-in page communicating the authentication of the user to the website.

The method may include the website posting a security assertion markup language (SAML) request to the third-party sign-in page. Therefore, the signing in phase may include the third-party sign-in page posting a SAML response to the website. Communicating the authentication of the user to the third-party sign-in page may include instructing the third-party sign-in page to post the SAML response to the website. The SAML response may contain the user identifier.

An administrator ID belonging to the website operator may be embedded in a URL of the third-party sign-in page. The administrator ID may be used to retrieve a private key of the website operator. The SAML response may be signed using the private key of the website operator. Therefore, the SAML response received by the website can be authenticated using a public key of the website operator.

It will be apparent to those skilled in the art that the method of the second aspect can be implemented using other login authentication protocols such as OAuth 2.0, OIDC and any other protocols which support a third-party IDP.

In a third aspect there is provided a computer-implemented method of digitally signing a document by a user, wherein a user identifier of the user has been registered according to the method of the first aspect, the method comprising an authentication phase and a digitally signing phase,
wherein the authentication phase includes:
   the trusted device obtaining subsequently acquired biometric data comprising the facial image of the user;
   transmitting the subsequently acquired biometric data, the user identifier, and the device token to the server;
   the server obtaining a hash value of the device token and a hash value of the user identifier and retrieving the privacy preserving data structure by reference to the hash value of the device token and the hash value of the user identifier;
   generating a private key from the privacy preserving data structure using the subsequently acquired biometric data; and
   decrypting the encrypted user identifier stored as metadata using the private key to authenticate the user,
wherein the digitally signing phase includes:
   providing the server with the document; and
   the server digitally signing the document using the private key.

By providing a method of digitally signing that requires the user to present biometric data, the user's digital signature can be more reliably authenticated.

The document (e.g. a PDF document) may be uploaded to the server by the user or by another user. The server may assign a document ID to the document. The other user may also specify the user as the signer of the document. The user may be specified by the user identifier.

The user may receive a signing link on the trusted device. The signing link may be sent to the email address of the user. The signing link may be generated by the server based on the document and/or the user identifier. The signing link may contain the document ID and/or the user identifier.

The method may include retrieving the document from the server and sending it to the trusted device by reference to the document ID and/or the user identifier, e.g. by following the signing link. This allows the user to review the document on the trusted device before the document is signed. The server and/or the trusted device may return an error if the document has already been signed by the user or if the document ID is invalid.

If the app discussed above with reference to the first aspect is installed on the trusted device, following the signing link may cause the trusted device to open the app. Alternatively, if the app is not installed on the trusted device, following the signing link may cause the trusted device to install the app. Following the signing link may prompt the user to perform the method of registration according to the first aspect using the trusted device.

The trusted device may determine an intent of the user to sign the document. For example, the user may select a sign option in the app. Obtaining the subsequently acquired biometric data may be in response to determining the intent of the user to sign the document. For example, the trusted device may prompt the user to scan their face.

The method may include the trusted device transmitting the document ID to the server, e.g. with any combination of the biometric data, the user identifier, and the device token. Therefore, the server may retrieve the document by reference to the document ID received from the trusted device. The server may verify that the user was specified as the signer when the document was uploaded.

Alternatively, when the document is uploaded to the server by the user, the document may be transmitted with any combination of the biometric data, the user identifier, and the device token.

The server may obtain a hash value of the user identifier transmitted from the trusted device and retrieve the privacy preserving data structure by reference to the hash value of the user identifier and the hash value of the device token.

The trusted device may return an error if the server cannot retrieve the privacy preserving data structure by reference to the hash value of the device token, and the hash value of the user identifier. This error may indicate that the trusted device is not associated with the user identifier on the server.

Additionally, or alternatively, the trusted device may return an error if the server can retrieve the privacy preserving data structure by reference to the hash value of the device token and/or the hash value of the user identifier but cannot authenticate the user.

Authenticating the user may include determining whether or not the subsequently acquired biometric data corresponds to the user identifier stored on the server. Therefore, the method may include determining that the user identifier can be decrypted by a private key generated from the biometric data and the privacy preserving data structure and by matching the decrypted user identifier stored as the metadata in the privacy preserving data structure to the user identifier transmitted to the server.

The digital signature created by signing the document using the private key can be verified using the public key. The public key certificate issued by the certificate authority may be retrieved from the public key registry by reference to the user identifier.

The method may include the server adding authentication metadata to the document, before signing the document using the private key. The authentication metadata may include information relating to the user, e.g. the user identifier corresponding to the public key of the user. The authentication metadata may be encrypted using a second public key belonging to the user. The method may include generating the second public key and a second privacy preserving data structure using the subsequently acquired biometric data and storing the encrypted authentication metadata in the second privacy preserving data structure. A second private key for decrypting the encrypted authentication metadata may be generated from the second privacy preserving data structure using further subsequently acquired biometric data comprising the facial image of the user. Therefore, the authentication metadata can be used to further verify that the document was signed by the user because the authentication metadata can only be decrypted with the user's face.

The authentication metadata may be encoded in a QR code which is added to the document, e.g. the second privacy preserving data structure may be encoded in the QR code. The method may include adding the authentication metadata on a new page of the document.

The method may include the server adding a timestamp to the document. The timestamp may be added before signing the document using the private key. Alternatively, the timestamp may be added after signing the document using the private key and the signed document may be additionally signed by a trusted timestamping authority.

The server may return a copy of the signed document to the user and/or the second user.

The method may be repeated for multiple recipients of the document for digitally signing. As such, the document may include authentication metadata of one or more additional signers.

In a fourth aspect, there is provided a public key infrastructure system for registering a user identifier, the system comprising:
a trusted device having a biometric sensor; and
a server in communication with the trusted device,
wherein the trusted device is configured to:
   receive the user identifier as an input; and
   obtain biometric data comprising a facial image of a user via the biometric sensor,
wherein at least one of the trusted device and the server is configured to:
   obtain a hash value of the user identifier;
   generate a public key and a privacy preserving data structure using the biometric data;
   encrypt the user identifier using the public key;
   store the encrypted user identifier as metadata in the privacy preserving data structure, wherein a private key for decrypting the encrypted user identifier can be generated from the privacy preserving data structure using subsequently acquired biometric data comprising the facial image of the user;
   generate a device token corresponding to the trusted device; and
   obtain a hash value of the device token,
wherein the server is configured to store the privacy preserving data structure uniquely indexed by the hash value of the device token and having the hash value of the user identifier as a primary key; and
wherein the trusted device is further configured to store the device token.

In a fifth aspect, there is provided a server comprising: a network interface, one or more processors, and a memory containing machine executable instructions which, when executed on the one or more processors, cause the one or more processors to:
connect to a trusted device via the network interface;
receive biometric data comprising a facial image of a user from the trusted device;
generate a public key and a privacy preserving data structure using the biometric data;
encrypt the user identifier using the public key;
store the encrypted user identifier as metadata in the privacy preserving data structure, wherein a private key for decrypting the encrypted user identifier can be generated from the privacy preserving data structure using subsequently acquired biometric data comprising the facial image of the user;
generate a device token corresponding to the trusted device;
obtain a hash value of the device token;
store, in the memory, the privacy preserving data structure indexed by the hash value of the device token and having the hash value of the user identifier as a primary key; and
transmit the device token to the trusted device.

In a sixth aspect, there is provided a trusted device comprising: a user interface, a biometric sensor, a communications interface, one or more processors, and a memory containing machine executable instructions which, when executed on the one or more processors, cause the one or more processors to:
receive the user identifier as an input via the user interface;
connect to a server via the communications interface;
transmit the user identifier to the server;
obtain biometric data comprising a facial image of a user via the biometric sensor;
transmit the biometric data to the server; and
receive a device token from the server.

In a seventh aspect, there is provided a public key infrastructure system according to the fourth aspect, the system further comprising a computing device for signing the user into a website, the computing device configured to:
redirect the user from the website to a third-party sign-in page connected to the server; and
display a unique code from the third-party sign-in page,
wherein the trusted device is further configured to:
   receive the unique code as an input;
   obtain subsequently acquired biometric data comprising the facial image of the user; and
   transmit the biometric data, the unique code, the user identifier, and the device token to the server,
wherein the server is further configured to:
   obtain a hash value of the device token and a hash value of the user identifier and retrieve the privacy preserving data structure by reference to the hash value of the device token and the hash value of the user identifier;
   generate a private key from the privacy preserving data structure using the subsequently acquired biometric data;
   decrypt the encrypted user identifier stored as metadata using the private key to authenticate the user;
   identify the third-party sign-in page from the unique code; and
   communicate the authentication of the user to the third-party sign-in page for signing the user into the website on the computing device.

In an eighth aspect, there is provided a public key infrastructure system according to the fourth aspect, wherein the trusted device is further configured to:
obtain subsequently acquired biometric data comprising the facial image of the user; and
transmit the subsequently acquired biometric data, the user identifier, and the device token to the server,
wherein the server is further configured to:
   obtain a hash value of the device token and a hash value of the user identifier and retrieve the privacy preserving data structure by reference to the hash value of the device token and the hash value of the user identifier;
   generate a private key from the privacy preserving data structure using the subsequently acquired biometric data;
   decrypt the encrypted user identifier stored as metadata using the private key to authenticate the user;
   receive a document for digitally signing;
   add authentication metadata to the document certifying the authentication of the user; and
   digitally sign the document using the private key.

Further aspects provide:
a computer program comprising code which, when run on a computer, causes the computer to perform any combination of the steps of at least one of the first aspect, the authentication phase of the second aspect, the signing in phase of the second aspect, the authentication phase of the third aspect, and/or the digitally signing phase of the third aspect; and/or a computer readable medium storing a computer program comprising code which, when run on a computer, causes the computer to perform any combination of the steps of at least one of the first aspect, the authentication phase of the second aspect, the signing in phase of the second aspect, the authentication phase of the third aspect, and/or the digitally signing phase of the third aspect.

### BRIEF DESCRIPTION OF THE FIGURES

Embodiments of the invention will now be discussed by way of example with reference to the accompanying figures in which:

FIG. 1 shows a schematic representation of a public key infrastructure system according to a first embodiment.

FIG. 2 shows a schematic representation of a trusted device of the public key infrastructure system of the first embodiment.

FIG. 3 shows a schematic representation of a server of the public key infrastructure system of the first embodiment.

FIG. 4 shows a flow chart of the steps of a method of registering a user identifier in the public key infrastructure of FIG. 1.

FIG. 5 shows a flow chart of further steps for authenticating the user in the method of FIG. 4.

FIG. 6 shows a user table illustrating registered data stored on the server.

FIG. 7 shows a mapping table illustrating mapping data stored on the server linking multiple user identifiers registered to the same trusted device.

FIG. 8 shows a flow chart of the steps of a method of registering multiple user identifiers using the same privacy preserving data structure.

FIG. 9 shows a schematic representation of a public key infrastructure system according to a second embodiment.

FIG. 10 shows a schematic representation of a computing device of the public key infrastructure system of the second embodiment.

FIG. 11 shows a flow chart of the steps of a method of signing a user into a website using third-party authentication.

FIG. 12 shows a flow chart of the steps of an authentication phase of the method of FIG. 11.

FIG. 13 shows a flow chart of the steps of a signing in phase of the method of FIG. 11.

FIG. 14 shows a flow chart of the steps of a method of setting up a Google® workspace login for third-party authentication.

FIG. 15 shows a flow chart of the steps of a method of digitally signing a document by a user.

FIG. 16 shows a flow chart of the steps of an authentication phase of the method of FIG. 15.

FIG. 17 shows a flow chart of the steps of a digitally signing phase of the method of FIG. 15.

### DETAILED DESCRIPTION OF THE EMBODIMENTS

Aspects and embodiments of the present invention will now be discussed with reference to the accompanying figures. Further aspects and embodiments will be apparent to those skilled in the art. All documents mentioned in this text are incorporated herein by reference.

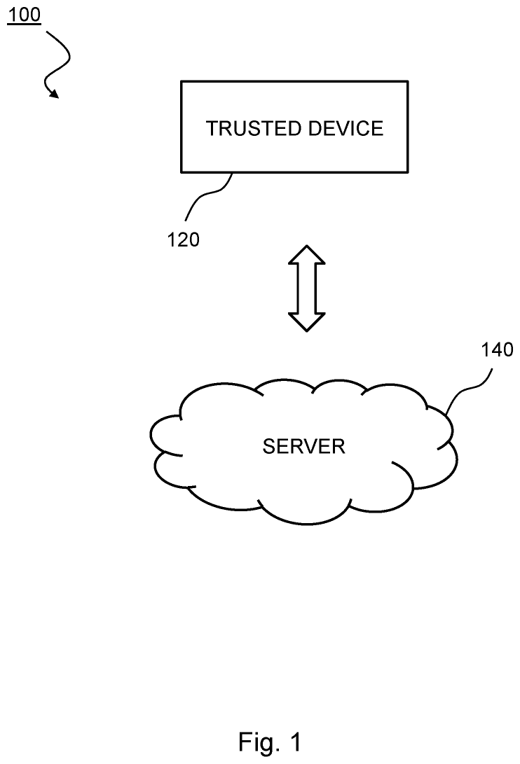

FIG. 1 shows a schematic representation of a public key infrastructure system 100. The public key infrastructure system 100 includes a trusted device 120 connected to a server 140.

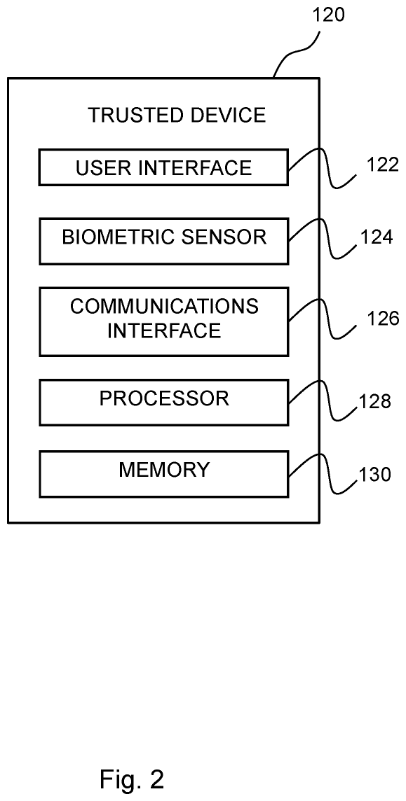

FIG. 2 shows a schematic representation of the trusted device 120, which is typically a smartphone belonging to a user. As such, the trusted device 120 has a user interface 122 for receiving information entered by the user. The trusted device 120 also includes a biometric sensor 124 which can be used to obtain a facial image of the user. A built-in camera, such as a front-facing camera, can be used as the biometric sensor 124. The trusted device 120 also has a communications interface 126 which is configured to transmit data to the server 140, as discussed in detail below. The trusted device 120 also has a processor 128 for running software stored in a memory 130 of the trusted device 120. Preferably, the software is installed as a mobile app.

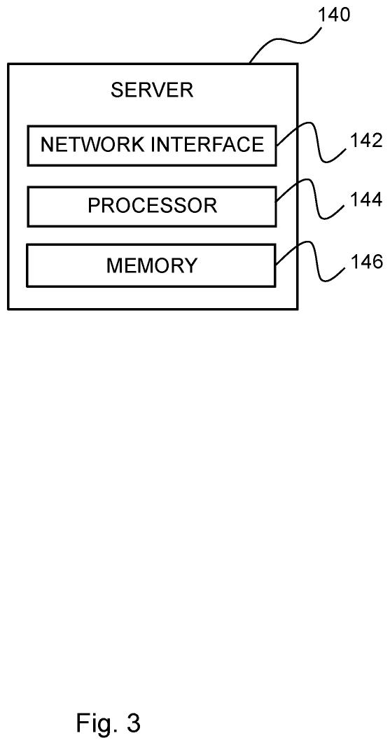

FIG. 3 shows a schematic representation of the server 140 of the public key infrastructure system 100. The server 140 includes a network interface 142 for exchanging data with the trusted device 120, a processor 144, and a memory 146.

A method of registering a user identifier in the public key infrastructure 100 will now be described in relation to the interactions between the trusted device 120 and the server 140.

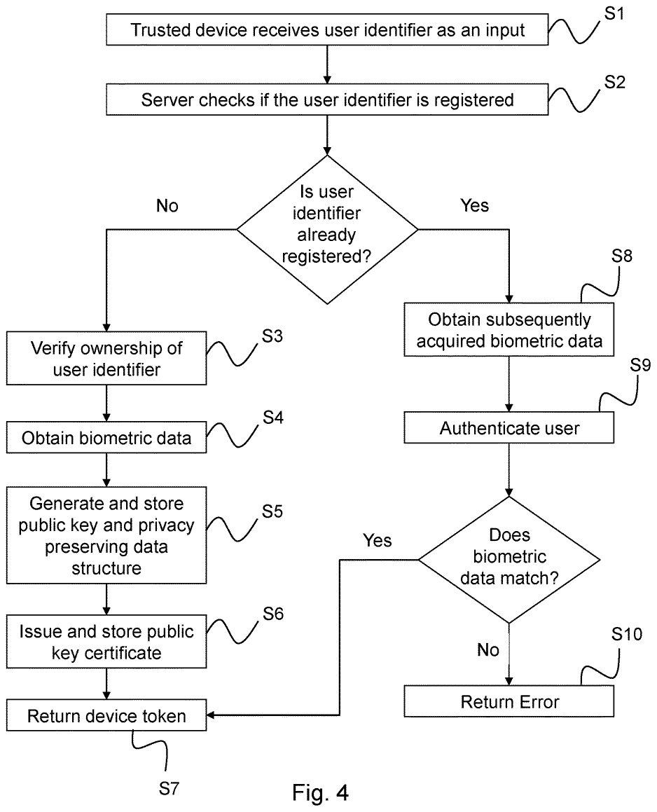

FIG. 4 shows a flow chart illustrating the main steps of the method. In a first step S1, the user inputs a user identifier into the trusted device 120. This may involve installing and opening the app on the trusted device 120.

Upon each start of the app, the app may use security methods such as device integrity checks to ensure that the device that the app is running on is a genuine uncompromised device. As an example, the Google® SafetyNet Attestation API or Play Integrity API provides such security checks. If a spurious device is detected, the app may cease to function, deleting all associated data.

The user identifier is preferably an email address, but other user identifiers may include a phone number, a crypto wallet identifier, or a physical address. The user identifier allows the user to be uniquely identified and, in the case of the email address or phone number, also allows the user to be contacted.

The trusted device 120 sends the user identifier to the server 140 via the communications interface 126 which connects to the network interface 142 of the server 140. Given that only one public key certificate may be issued per user identifier, in step S2 the server 140 checks if the user identifier has already been registered. As discussed further below, the server 140 does not store user identifiable information for improved security. Therefore, the server 140 stores hash values of user identifiers instead of the user identifiers. Hence, in step S2 the server 140 obtains a hash value of the user identifier and determines whether or not the hash value is already stored on the server 140.

If the hash value of the user identifier is not found on the server 140 then it is determined that the user identifier has not already been registered. Accordingly, the method proceeds to step S3 in which the ownership of the user identifier is verified. As an example, when the user identifier is an email address or phone number, the server may send a one-time password (OTP) to the email address or phone number and the user may be required to enter the OTP on the app. If ownership of the user identifier cannot be verified, then the user may not be allowed to register the user identifier.

Following successful verification of ownership, in step S4 the trusted device 120 obtains biometric data comprising the facial image of the user via the biometric sensor 124. The user may be prompted by the mobile app to scan or photograph their face using the built-in phone camera. Next, in step S5, the trusted device 120 sends the biometric data to the server 140, which uses the biometric data to generate a public key and a privacy preserving data structure from which a corresponding private key can be generated later using other (subsequently) acquired biometric data. The user identifier is encrypted using the public key and stored as metadata in the privacy preserving data structure. The private key which can be generated from the privacy preserving data structure when required is able to decrypt the encrypted user identifier.

Once the public key is generated, in step S6, a root Certificate Authority (CA) is requested via a certificate signing request to issue a public key certificate for the user identifier and the public key. The root CA may be a cloud private CA service such as that provided by AWS® with its private key being protected in a cloud hardware security module. The public key certificate thus issued is stored (e.g. encrypted) in a public key registry (not shown). The public key certificate may be downloaded from the public key registry by providing the user identifier.

In step S7, the server 140 generates a device token corresponding to the trusted device 120 and returns the device token to the trusted device 120. The device token is a required parameter for any cryptographic operations with the user's face and, therefore, only one device token is provided per trusted device. Additionally, each user identifier may only be registered with one trusted device.

For improved security, the device token is only retained by the trusted device 120. As such, the copy of the device token on the server 140 is discarded. Nevertheless, before discarding the device token, the server 140 obtains a hash value of the device token and stores the privacy preserving data structure indexed by the hash value of the device token and having the hash value of the user identifier as a primary key. This allows the privacy preserving data structure to be retrieved by reference to the hash value of the device token when required, as discussed further below.

Turning again to step S2, if the hash value of the user identifier is found to be already stored on the server 140 then it is determined that the user identifier has already been registered. The subsequent method steps enable the user to re-register the user identifier with the trusted device 120 replacing an older trusted device (not shown).

In step S8, in response to receiving an indication from the server 140 that the user identifier has already been registered, the trusted device 120 obtains subsequent biometric data comprising the facial image of the user via the biometric sensor 124. Again, the user may be prompted by the app to scan or photograph their face using the built-in phone camera. The subsequently acquired biometric data is sent to the server 140 for authenticating the user against the user identifier.

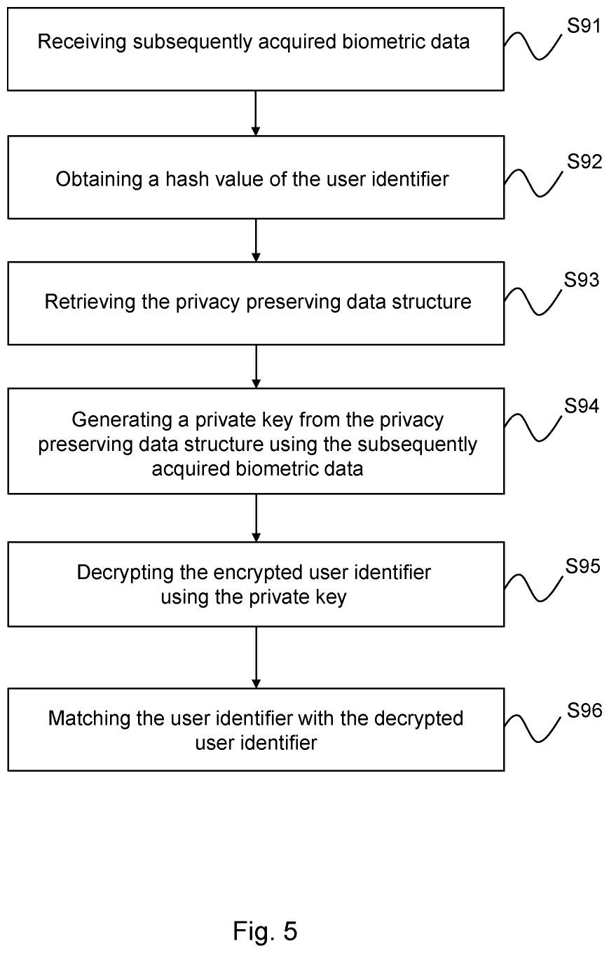

FIG. 5 shows a flow chart of the specific method steps involved in authenticating the user. In step S91, the server 140 receives the subsequently acquired biometric data from the trusted device 120. In step S92, the server 140 obtains a hash value of the user identifier which is used as a reference for retrieving the privacy preserving data structure in step S93.

In step S94, the subsequently acquired biometric data is used to generate the user's private key from the privacy preserving data structure. If the biometric data used to create the privacy preserving data structure is the same as the subsequently acquired biometric data used to generate the private key, then the private key corresponds to the public key registered with the user identifier. Accordingly, in step S95, the private key is able to decrypt the encrypted user identifier stored in the privacy preserving data structure. In step S96, successful decryption is confirmed by matching the decrypted user identifier to the user identifier received from the trusted device 120.

The decryption will be unsuccessful if the biometric data does not match, in which case the server returns an error (step S10). Otherwise, following authentication of the user the method proceeds to step S7 and the server 140 generates a device token which is provided to the trusted device 120. The device token may be a new device token to replace an existing device token associated with the user identifier. This ensures that only one public key certificate is issued per user identifier and that only one trusted device can be used to gain access to the private key. The older trusted device may be logged out automatically by the server 140 with the server returning an error when the older device tries to authenticate with it by sending an old device token which is no longer in existence at the server.

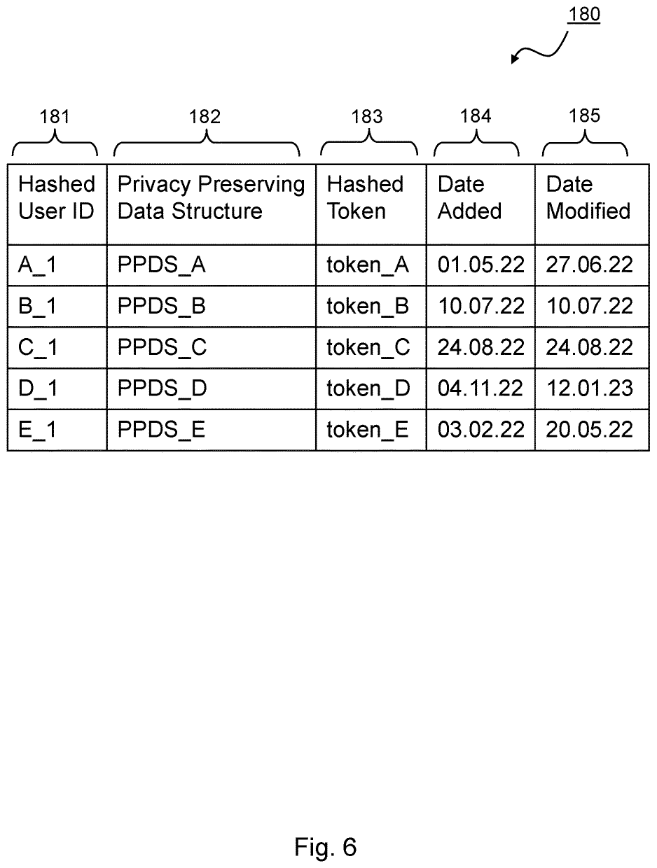

FIG. 6 shows a user table 180 illustrating the registered data stored on the server 140. An entry of the registered data includes the hash value of the user identifier 181, the privacy preserving data structure 182, the hash value of the device token 183, a date added 184 corresponding to the date on which the entry was added to the user table 180, and a date modified 185 corresponding to the most recent date when the entry was modified, e.g. by changing the hash value of the device token 183 when replacing the trusted device 120. The hash value of the user identifier 181 forms a primary key of the user table 182. Each privacy preserving data structure may be retrieved by reference to the hash value of the user identifier 181 and/or the hash value of the device token 183, or when both the hash value of the user identifier and the hash value of the device identifier match the entries in a particular row of the user table 180.

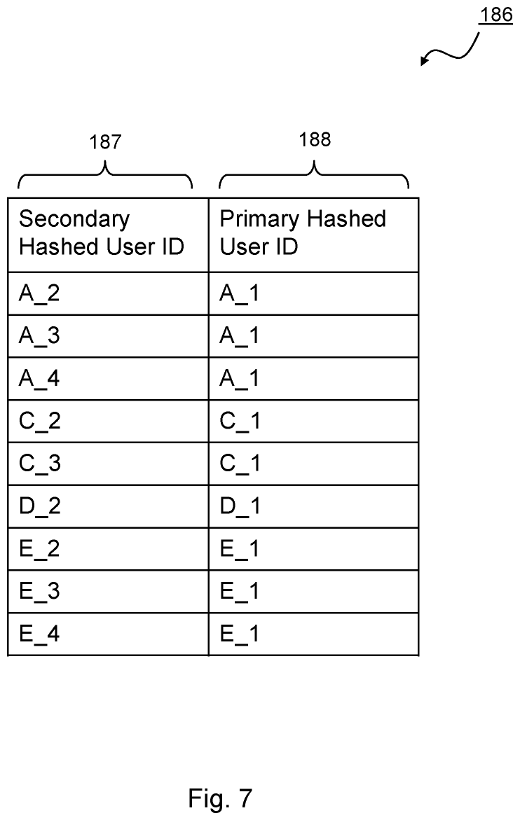

FIG. 7 shows a mapping table 186 illustrating mapping data stored on the server 140, which links multiple user identifiers registered to the same trusted device 120. When an additional user identifier is registered, the server 140 may obtain a hash value of the additional user identifier and store the hash value of the additional user identifier with the hash value of the user's primary user identifier in the mapping table 186. As such, an entry of the mapping data includes the hash value of the additional (secondary) user identifier 187 and the hash value of the original (primary) user identifier 188. The additional user identifier forms a primary key of the mapping table such that the mapping table 186 maps the additional user identifiers to the original user identifiers stored in the user table 180. As a result, multiple user identifiers can be registered on the server 140 and linked to a single privacy preserving data structure for efficient storage utilisation.

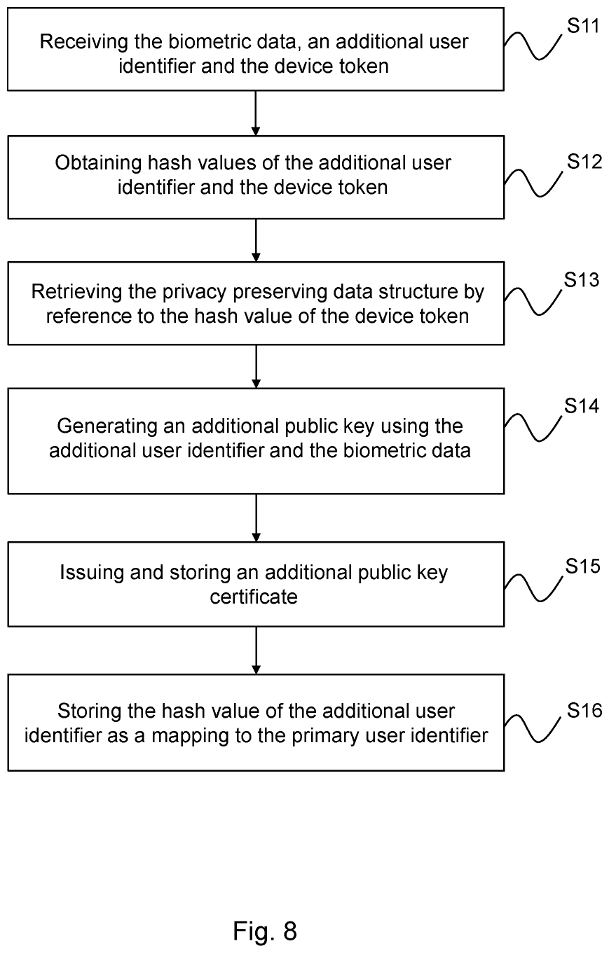

FIG. 8 shows a flow chart illustrating the steps of a method of registering multiple user identifiers using the same privacy preserving data structure.

In step S11, the server 140 receives from the trusted device 120 an additional user identifier and the device token of the trusted device 120, along with the biometric data of the user. In step S12, the server 140 obtains hash values of the device token and the additional user identifier, respectively. The hash value of the device token is used in step S13 to retrieve the privacy preserving data structure stored

Subsequently, in step S14, an additional public key is generated using the biometric data and also the additional user identifier. Specifically, the additional user identifier is used as a unique string to generate a different public key. A corresponding private key can be generated from the privacy preserving data structure later using other (subsequently) acquired biometric data as well as the additional user identifier string. The additional user identifier is encrypted using the additional public key and stored as metadata in the privacy preserving data structure. The additional private key which can be generated from the privacy preserving data structure when required is able to decrypt the encrypted additional user identifier.

Once the additional public key is generated, the root CA is requested via a certificate signing request to issue a public key certificate for the additional user identifier and the additional public key (step S15). This public key certificate is then stored (e.g. encrypted) in the public key registry with the other public key certificate(s) and may be downloaded from the public key registry by providing the additional user identifier.

In step S16, the hash value of the additional user identifier is stored as a reference to the privacy preserving data structure. For example, the additional user identifier may be stored in a new entry of the mapping table 186 as a primary key to the original user identifier stored in the user table 180.

As a result, multiple user identifiers can be associated with the same account and authenticated using the same trusted device 120.

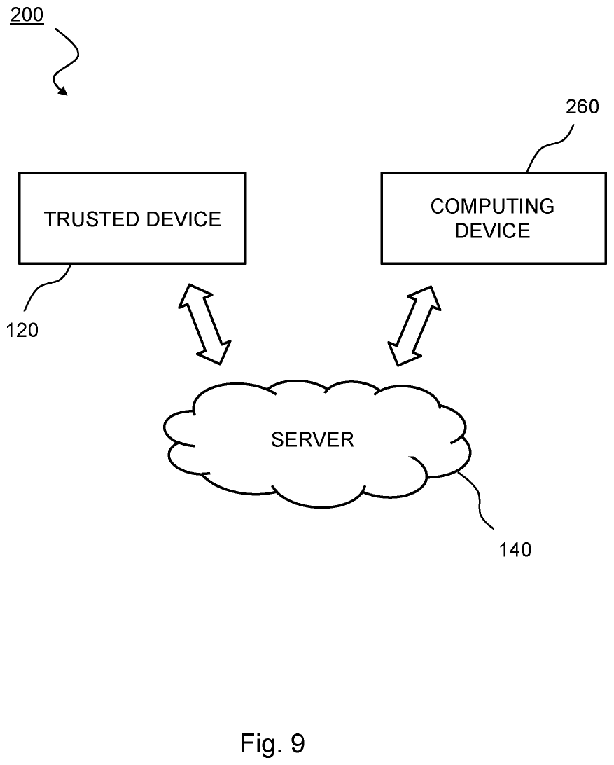

FIG. 9 shows a schematic representation of a public key infrastructure system 200 according to a second embodiment which is a development of the first embodiment. The public key infrastructure system 200 includes the trusted device 120 and the server 140 of the system 100, in addition to a computing device 260 which is connected to the server 140.

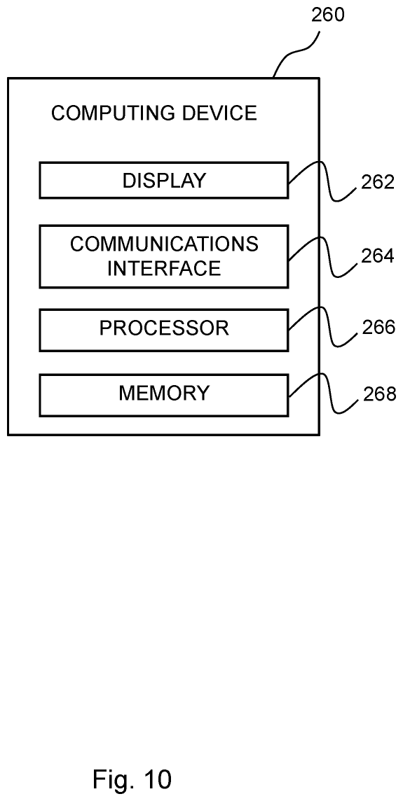

FIG. 10 shows a schematic representation of the computing device 260 of the public key infrastructure system 200. The computing device 260 has a display 262 such as a monitor for displaying website information to the user. The computing device 260 also includes a communications interface 262 which is configured to transmit data to the server 140, as discussed in detail below. The computing device 260 also has a processor 266 for running software stored in a memory 268 of the computing device 268.

A method of signing a user into a website on the computing device 260 using third-party authentication will now be described in relation to the interactions between the trusted device 120, the server 140, and the computing device 260.

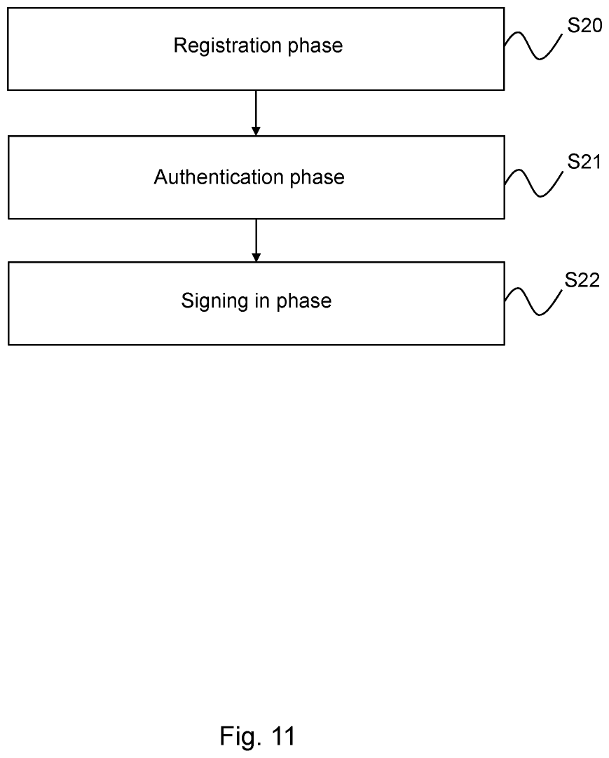

FIG. 11 shows a flow chart illustrating the main steps of the signing in method. The method includes a registration phase (step S20), an authentication phase (step S21), and a signing in phase (step S22). The registration phase corresponds to the method of registering a user identifier in the public key infrastructure system 100 of the first embodiment, as described above. The subsequent authentication and signing in phases are discussed in further detail below.

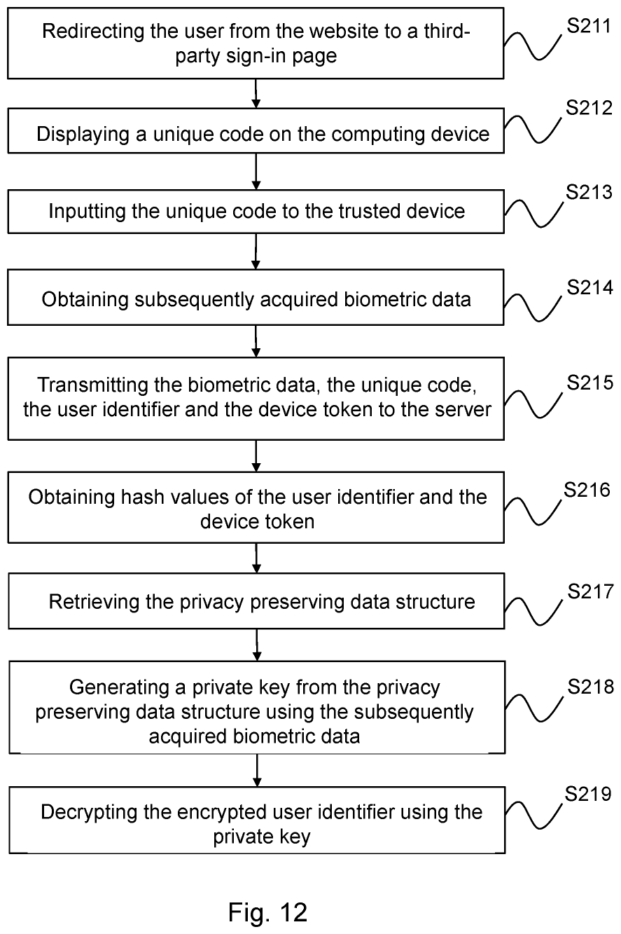

FIG. 12 shows a flow chart of the steps of the authentication phase of the method. This phase corresponds to the identity of the user being authenticated following an attempt of the user to sign into the website.

The authentication phase begins in step S211 wherein the user is redirected from the website to a third-party sign-in page. The website may determine an intent of the user to sign in to the website when the user inputs a user identifier such as their email address into the website. Hence, the user may be redirected to the third-party sign-in page in response to this determination. The third-party sign-in page maintains a connection (e.g. using socket. io) with the server 140 for receiving information regarding the authentication of the user. It is also contemplated that instead of maintaining a connection, the frontend sign in page periodically polls the backend server for receiving information In step S212, the third-party sign-in page displays a unique code, which the user inputs into the trusted device in step S213. Preferably, the unique code is displayed as a QR code for the user to scan using a camera on the trusted device. However, the unique code may be an alphanumeric code instead, which can be input to the trusted device manually via the user interface 122.

Upon receiving the unique code, the app may prompt the user to scan their face. Accordingly, in step S214, the trusted device 120 obtains (subsequent) biometric data comprising a facial image of the user. This biometric data is transmitted to the server 140 in step S215, along with the unique code, the user identifier, and the device token. The server may check if the unique code has expired, in which case server returns an error to the trusted device 120. Otherwise, the method proceeds to step 216 wherein the server 140 obtains hash values of the user identifier and the device token, respectively.

In step 217, the hash value of the user identifier is used to retrieve the privacy preserving data structure linked to the user identifier. If the privacy preserving data structure cannot be retrieved and/or the device token is invalid, then the server 140 returns an error to the trusted device 120.

If the device token is valid, the server 140 generates a private key from the privacy preserving data structure in step S218 using the subsequently acquired biometric data. The private key is used in step S219 to decrypt the encrypted user identifier stored in the privacy preserving data structure. Successful decryption is confirmed by matching the decrypted user identifier to the user identifier received from the trusted device 120. The decryption will be unsuccessful if the biometric data does not match, in which case the server may return an error to the trusted device 120.

By generating the user's private key, the server 140 authenticates the identity of the user corresponding to their user identifier because only the user is able to generate the private key using their unique biometric data.

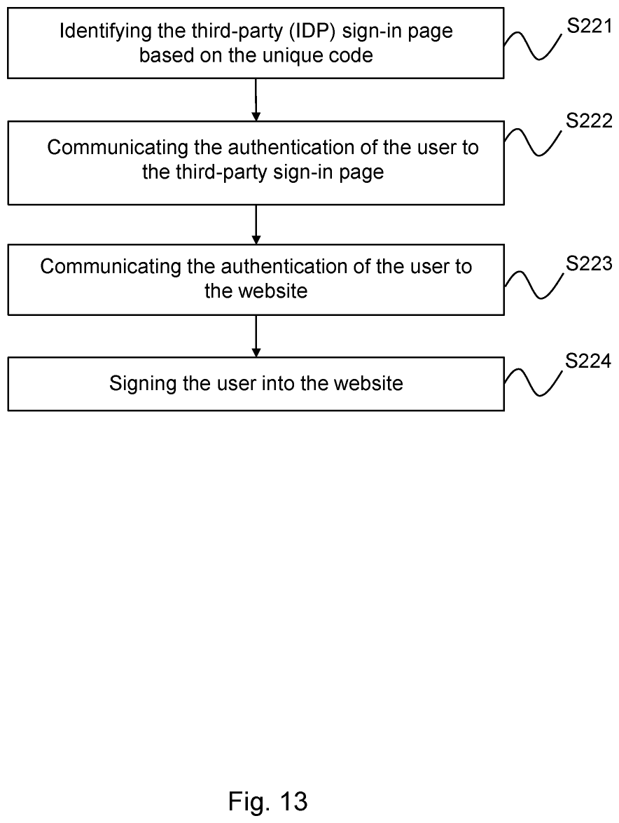

FIG. 13 shows a flow chart of the steps of the signing in phase of the method, which follows the authentication of the user. In step S221, the server 140 identifies the third-party sign-in page based on the unique code displayed by the third-party sign-in page which was transmitted to the server 140. Subsequently, in step S222, the server 140 communicates the authentication of the user to the third-party sign-in page. In other words, the third-party sign-in page receives confirmation that the user attempting

Therefore, in step S223, the third-party sign-in page communicates the authentication of the user to the website. For example, in accordance with instructions received from the server 140, the third-party sign-in page may post a SAML response containing the user identifier to the website, to assert that the user has been authenticated. Additionally, the third-party sign-in page may redirect the user to the website.

Thus, in step S224, the website allows the authenticated user to sign in.

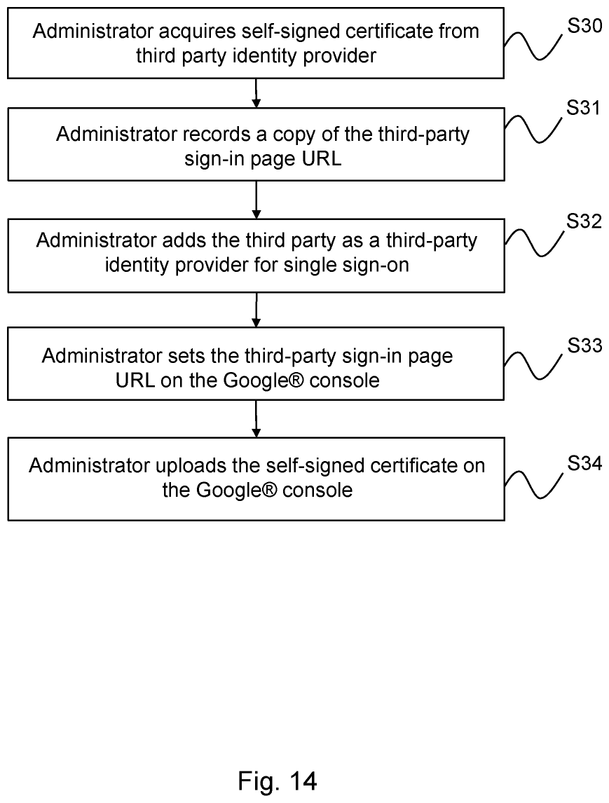

Methods of configuring a website for third-party authentication will be apparent to the skilled person. For example, FIG. 14 shows a flow chart of a method for a website operator setting up a Google® workspace login for third-party authentication.

In step S30, the website operator as an administrator acquires a self-signed certificate from a third-party identity provider. Specifically, the administrator signs up for or signs into a website which is generically called the Face-based public key infrastructure (PKI) website. If the Face-based PKI website determines that users are from a Google Workspace domain, then a self-signed certificate is created for the administrator to download.

Since certificates are linked to customers (e.g. log-in email), the URL of the third-party sign-in page is different for each customer and an administrator ID is embedded in the URL. This administrator ID can later be used by the server 140 to retrieve the administrator's private key and certificate. Thus, in step S31, the administrator notes down the URL for future reference.

In step S32, the administrator logs in to their Google Workspace as an administrator and selects to add the third party (Face-based PKI) as a third-party identity provider for single sign-on (SSO). On the configuration page, the administrator also sets the third-party sign-in page URL on the Google® console, in step S33. This is the same URL recorded in step S31.

In step S34, the administrator uploads the self-signed certificate acquired in step S30 and saves their settings.

Since the administrator ID belonging to the website operator is embedded in the third-party sign-in page URL, the administrator ID may be used by the third-party IDP server to retrieve the private key of the website operator for signing the SAML response before posting the SAML response to the website.

A method of digitally signing a document by a user will now be described in relation to the interactions between the trusted device 120 and the server 140 of public key infrastructure system 100.

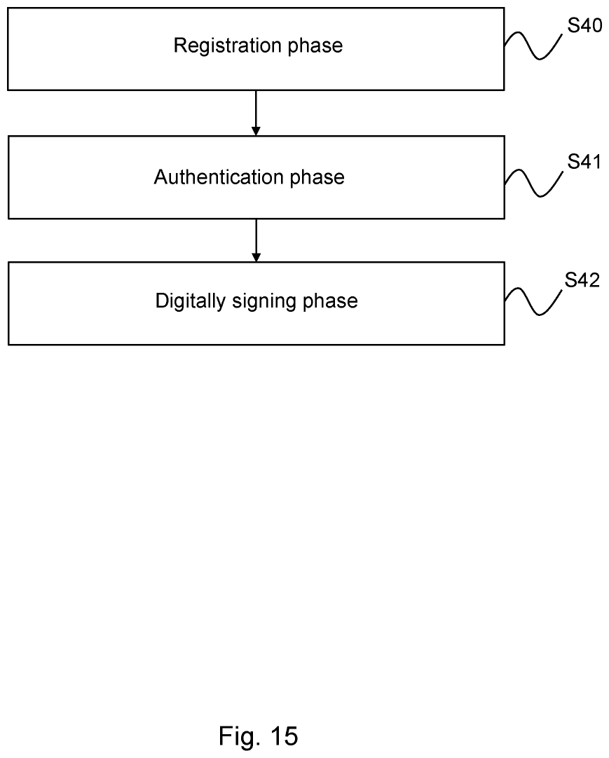

FIG. 15 shows a flow chart illustrating the main steps of the digitally signing method. The method includes a registration phase (step S40), an authentication phase (step S41), and a digitally signing (step S42). The registration phase corresponds to the method of registering a user identifier in the public key infrastructure system 100 of the first embodiment, as described above. The subsequent authentication and digitally signing phases are discussed in further detail below.

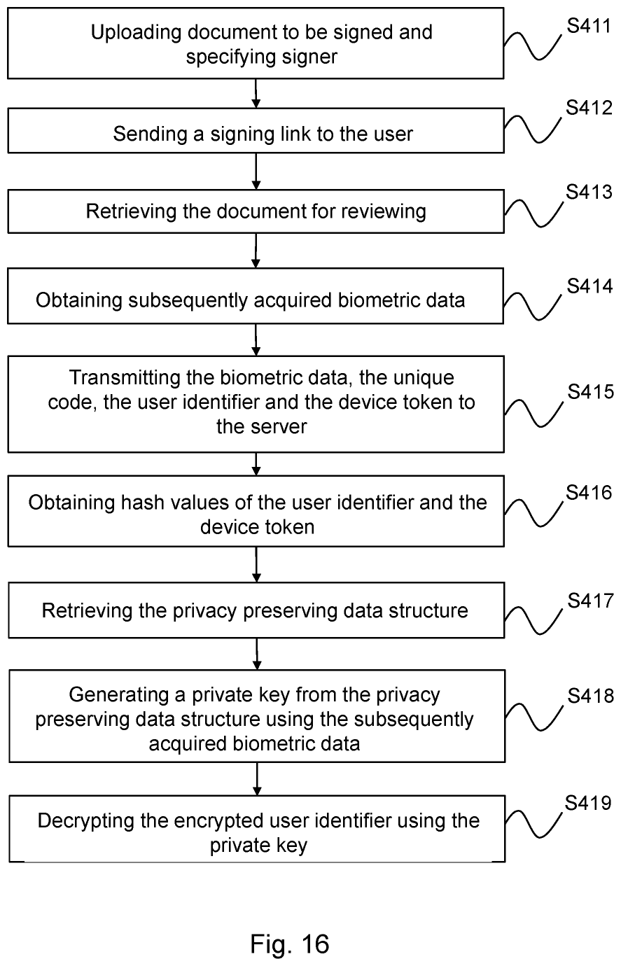

FIG. 16 shows a flow chart of the steps of the authentication phase of the method. This phase corresponds to the identity of the user being authenticated in order to digitally sign the document.

The authentication phase begins in step S411 wherein the document to be signed (e.g. a PDF) is uploaded to the server 140 and the intended signer of the document is specified. Preferably, the user is specified by their user identifier allowing the signer to be contacted. Henceforth, the signer is referred to as the user.

The server assigns a document ID to the document and sends the user a signing link containing the document ID and the user identifier in step S412. The signing link is preferably sent in an email to the email address which is the user identifier. Alternatively, where the user identifier is a phone number, the signing link may be sent via an SMS text message. The app opens automatically by following the signing link on the trusted device 120. If the app has not been installed, then the signing link will prompt the user to install the app and register the user identifier with the trusted device 120.

Using the document ID embedded in the signing link, the trusted device 120 retrieves the document to be signed from the server 140 allowing the user to review the document in step S413. When the user is ready to sign the document, the user can select on option to sign via the user interface 122.

In response to the user selecting the option to sign, the trusted device 120 obtains subsequent biometric data comprising the facial image of the user via the biometric sensor 124. The user may be prompted by the app to scan or photograph their face using the built-in phone camera.

The subsequently acquired biometric data is sent to the server 140 for authenticating the user against the user identifier. Hence, in step S415, the trusted device 120 also transmits the document ID, the device token and the user identifier, with the biometric data.

In step S416, the server 140 obtains hash values of the user identifier and the device token, respectively.

In step 417, the hash value of the user identifier and the hash value of the device token are used to retrieve the privacy preserving data structure linked to the user identifier and device token. If the privacy preserving data structure cannot be retrieved and/or the device token is invalid, then the server 140 returns an error to the trusted device 120.

If the device token is valid, the server 140 generates a private key from the privacy preserving data structure in step S418 using the subsequently acquired biometric data. The private key is used in step S419 to decrypt the encrypted user identifier stored in the metadata section of the privacy preserving data structure. Successful decryption is confirmed by matching the decrypted user identifier to the user identifier received from the trusted device 120. The decryption will be unsuccessful if the biometric data does not match, in which case the server may return an error to the trusted device 120.

By generating the user's private key, the server 140 authenticates the identity of the user corresponding to their user identifier because only the user is able to generate the private key using their unique biometric data.

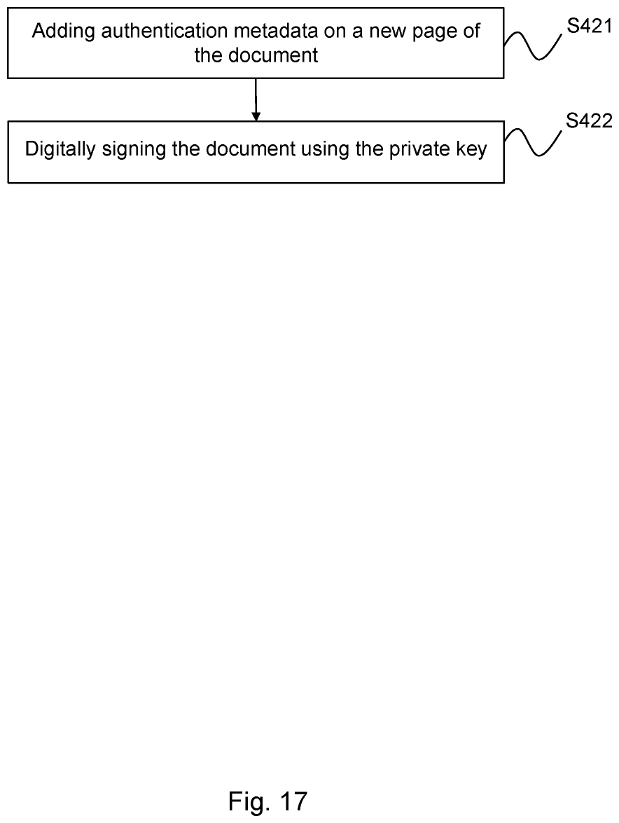

FIG. 17 shows a flow chart of the steps of the digitally signing phase of the method, which follows the authentication of the user.

Since the biometric data is valid, and a private key could be generated from the privacy preserving data structure, in step S421, the server 140 adds a new page to the document and includes authentication metadata. Preferably, the authentication metadata is embedded in a QR code, which can be scanned to obtain signing details. For example, the authentication metadata may include information relating to the user, e.g. the user identifier and may also include information related to the document, e.g. the document ID.

The server 140 may generate a second public key using the subsequently acquired biometric data and encrypt the authentication metadata using the second public key. As such, the QR code may comprise a second privacy preserving data structure storing the authentication metadata, the second privacy preserving data structure also being generated using the subsequently acquired biometric data. A second private key for decrypting the encrypted authentication metadata may be generated from the second privacy preserving data structure using further subsequently acquired biometric data comprising the facial image of the user. Therefore, the authentication metadata can be used to further verify that the document was signed by the user because the authentication metadata can only be decrypted with the user's face.

In step S422, after adding the authentication metadata, the document is signed using the private key generated in step S418. Preferably, the document is also timestamped by a trusted timestamping authority.

Thus, the signed document is cryptographically signed after adding a page containing the signer's information in the form of a QR code. The QR code can only be decrypted using the signer's face and the decrypted information can contain useful metadata information about the document and the signer.

The systems and methods of the above embodiments may be implemented in a computer system (in particular in computer hardware or in computer software) in addition to the structural components and user interactions described.

The term “computer system” includes the hardware, software and data storage devices for embodying a system or carrying out a method according to the above-described embodiments. For example, a computer system may comprise a central processing unit (CPU), input means, output means and data storage. The computer system may have a monitor to provide a visual output display. The data storage may comprise RAM, disk drives or other computer readable media. The computer system may include a plurality of computing devices connected by a network and able to communicate with each other over that network.

The methods of the above embodiments may be provided as computer programs or as computer program products or computer readable media carrying a computer program which is arranged, when run on a computer, to perform the method(s) described above.

The term “computer readable media” includes, without limitation, any non-transitory medium or media which can be read and accessed directly by a computer or computer system. The media can include, but are not limited to, magnetic storage media such as floppy discs, hard disc storage media and magnetic tape; optical storage media such as optical discs or CD-ROMs; electrical storage media such as memory, including RAM, ROM and flash memory; and hybrids and combinations of the above such as magnetic/optical storage media.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A computer-implemented method of registering a user identifier in a public key infrastructure, the public key infrastructure comprising a server and a trusted device, the method including:
receiving the user identifier as an input to the trusted device;
obtaining a hash value of the user identifier;
obtaining, by the trusted device, biometric data comprising a facial image of the user;
generating a public key and a privacy preserving data structure using the biometric data;
encrypting the user identifier using the public key;
storing the encrypted user identifier as metadata in the privacy preserving data structure, wherein a private key for decrypting the encrypted user identifier can be generated from the privacy preserving data structure using subsequently acquired biometric data comprising the facial image of the user;
generating a device token corresponding to the trusted device;
obtaining a hash value of the device token;
storing, by the server, the privacy preserving data structure uniquely indexed by the hash value of the device token while using the hash value of the user identifier as a primary key; and
storing, by the trusted device, the device token.

2. The computer-implemented method of claim 1, wherein the method further includes forwarding the user identifier and the biometric data to the server, wherein the public key and the privacy preserving data structure are generated by the server.

4. The computer-implemented method of claim 1, wherein the device token is generated by the server and transmitted to the trusted device.

5. The computer-implemented method of claim 4, wherein the server does not store a copy of the device token after transmitting the device token to the trusted device.

6-8. (canceled)

9. The computer-implemented method of claim 1, further comprising determining if the user identifier is associated with an existing privacy preserving data structure stored on the server.

10. The computer-implemented method of claim 9, further including searching for the hash value of the user identifier on the server.

11. The computer-implemented method of claim 9, further comprising:
authenticating the user in response to determining that the user identifier is associated with the existing privacy preserving data structure stored on the server.

12. The computer-implemented method of claim 11, wherein authenticating the user includes:
obtaining subsequently acquired biometric data comprising the facial image of the user;
retrieving, by the server, the existing privacy preserving data structure by reference to the hash value of the user identifier;
generating a private key from the existing privacy preserving data structure using the subsequently acquired biometric data; and
decrypting the encrypted user identifier stored in the existing privacy preserving data structure using the private key to authenticate the user.

13. The computer-implemented method of claim 1, wherein the device token is a new device token to replace an existing device token associated with the user identifier.

14. The computer-implemented method of claim 1, further comprising:
requesting, by the server, public key certificate from a certificate authority for the public key and the user identifier; and
storing, by the certificate authority, the public key certificate in a public key registry.

15-27. (canceled)

28. A public key infrastructure system for registering a user identifier, the system comprising:
a trusted device having a biometric sensor; and
a server in communication with the trusted device,
wherein the trusted device is configured to:
receive the user identifier as an input; and
obtain biometric data comprising a facial image of a user via the biometric sensor,
wherein at least one of the trusted device and the server is configured to:
obtain a hash value of the user identifier;
generate a public key and a privacy preserving data structure using the biometric data;
encrypt the user identifier using the public key;
store the encrypted user identifier as metadata in the privacy preserving data structure, wherein a private key for decrypting the encrypted user identifier can be generated from the privacy preserving data structure using subsequently acquired biometric data comprising the facial image of the user;
generate a device token corresponding to the trusted device; and
obtain a hash value of the device token,
wherein the server is configured to store the privacy preserving data structure uniquely indexed by the hash value of the device token and having the hash value of the user identifier as a primary key, and
wherein the trusted device is further configured to store the device token.

29. The public key infrastructure system of claim 28, the system further comprising a computing device configured to:
redirect a user from a website to a third-party sign-in page connected to the server; and
display a unique code from the third-party sign-in page,
wherein the trusted device is further configured to:
receive the unique code as an input;
obtain subsequently acquired biometric data comprising the facial image of the user; and
transmit the biometric data, the unique code, the user identifier, and the device token to the server.

30. The public key infrastructure system of claim 28, wherein the trusted device is further configured to:
obtain subsequently acquired biometric data comprising the facial image of the user; and
transmit the subsequently acquired biometric data, the user identifier, and the device token to the server.

31. A server comprising:
a network interface,
one or more processors, and
a memory containing machine executable instructions which, when executed on the one or more processors, cause the one or more processors to:
connect to a trusted device via the network interface;
receive biometric data comprising a facial image of a user from the trusted device;
generate a public key and a privacy preserving data structure using the biometric data;
encrypt a user identifier using the public key;
store the encrypted user identifier as metadata in the privacy preserving data structure, wherein a private key for decrypting the encrypted user identifier can be generated from the privacy preserving data structure using subsequently acquired biometric data comprising the facial image of the user;
generate a device token corresponding to the trusted device;
obtain a hash value of the device token;
store, in the memory, the privacy preserving data structure uniquely indexed by the hash value of the device token and having the hash value of the user identifier as a primary key; and
transmit the device token to the trusted device.

32. (canceled)

33. The server of claim 31, wherein the machine executable instructions which, when executed on the one or more processors, further cause the one or more processors to:
store a plurality of privacy preserving data structures that are each associated with a respective hash of a different respective user identifier.

34. The server of claim 33, wherein the hash value of the user identifier is a first hash value of a first user identifier, wherein the privacy preserving data structure is a first privacy preserving data structure associated with the first hash value of the first user identifier, wherein the plurality of privacy preserving data structures include a second privacy preserving data structure that is associated with a second hash of a second user identifier.

35. The server of claim 33, wherein the machine executable instructions which, when executed on the one or more processors, further cause the one or more processors to:
receive an authentication request that includes a particular device token; and
search the plurality of privacy preserving data structures for a particular privacy preserving data structure that is associated with the particular device token.

36. The server of claim 31, wherein the privacy preserving data structure is a first privacy preserving data structure, wherein the hash value of the user identifier is a first hash value of a first user identifier associated with a first user, wherein the machine executable instructions which, when executed on the one or more processors, further cause the one or more processors to:
store, in the memory, a second privacy preserving data structure that is associated with the hash value of the device token and a second hash value associated with a second user identifier associated with a second user.

37. The public key infrastructure system of claim 29, wherein the server is further configured to:
obtain a hash value of the device token and a hash value of the user identifier and retrieve the privacy preserving data structure by reference to the hash value of the device token and the hash value of the user identifier;
generate a private key from the privacy preserving data structure using the subsequently acquired biometric data;
decrypt the encrypted user identifier stored as metadata using the private key to authenticate the user;
identify the third-party sign-in page from the unique code; and
communicate the authentication of the user to the third-party sign-in page for signing the user into the website on the computing device.

38. The public key infrastructure system of claim 30, wherein the server is further configured to:
obtain a hash value of the device token and a hash value of the user identifier and retrieve the privacy preserving data structure by reference to the hash value of the device token and the hash value of the user identifier;
generate a private key from the privacy preserving data structure using the subsequently acquired biometric data;
decrypt the encrypted user identifier stored as metadata using the private key to authenticate the user;
receive a document for digitally signing; and
digitally sign the document using the private key.
